(19) United States
(12) Patent Application Publication
(10) Pub. No.: US 2015/0006518 A1
(43) Pub. Date: Jan. 1, 2015

(54) VISUALIZATIONS BASED ON NATURAL LANGUAGE QUERY

(71) Applicant: Microsoft Corporation, Redmond, WA (US)

(72) Inventors: Patrick J. Baumgartner, Kirkland, WA (US); Amir M. Netz, Bellevue, WA (US); Pedram Faghihi Rezaei, Seattle, WA (US); Sharath Kodi Udupa, Seattle, WA (US)

(21) Appl. No.: 13/929,435

(22) Filed: Jun. 27, 2013

(51) Int. Cl. G06F 17/30

(52) U.S. Cl. CPC G06F 17/30554
USPC 707/723

(57) ABSTRACT

Providing visualizations based on natural language searches. A method includes receiving a natural language query from a client. The method further includes based on the natural language query, obtaining a semantic model of the natural language query. The method further includes based on the semantic model, obtaining a list of a plurality of visualizations, the visualizations being based on a bias ranking of the visualizations in the list. The method further includes providing the list of the plurality of visualizations to the client, where at the client a set of visualization construction rules are applied to select a visualization from the list to apply results from the natural language query to the visualization.

### BACKGROUND

1. Background and Relevant Art

Computers and computing systems have affected nearly every aspect of modern living. Computers are generally involved in work, recreation, healthcare, transportation, entertainment, household management, etc.

Many computers are intended to be used by direct user interaction with the computer. As such, computers have input hardware and software user interfaces to facilitate user interaction. For example, a modern general purpose computer may include a keyboard, mouse, touchpad, camera, etc. for allowing a user to input data into the computer. In addition, various software user interfaces may be available. Examples of software user interfaces include graphical user interfaces, text command line based user interface, function key or hot key user interfaces, and the like.

User interfaces are often configured to provide visualizations of data. For example, data may be shown in graphical format, in list or table format, or in other formats that allow a user to consume the data. As data can be provided in various different visualizations, there may be some challenges in selecting the “best” visualization for some set of data.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment includes a method which includes acts for providing visualizations based on natural language searches. The method includes receiving a natural language query from a client. The method further includes based on the natural language query, obtaining a semantic model of the natural language query. The method further includes based on the semantic model, obtaining a list of a plurality of visualizations, the visualizations being based on a bias ranking of the visualizations in the list. The method further includes providing the list of the plurality of visualizations to the client, where at the client a set of visualization construction rules are applied to select a visualization from the list to apply results from the natural language query to the visualization.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example flow of messages between systems to interpret a natural language query;

FIG. 2 illustrates a table with evaluation rules that can be evaluated to evaluate visualizations;

FIG. 3 illustrates a table illustrating how visualizations are built at a client; and

FIG. 4 illustrates a method of providing visualizations.

### DETAILED DESCRIPTION

Selection of the “best” visualization may be dependent on context—including the data itself, the capabilities of the visualization tool, what consumer of the visualization is explicitly or implicitly asking for, and any pre-conceived notions of what a visualization should be, based on the consumers past experiences and tastes.

Given this range of variables, some embodiments described herein implement automatic selection of a visualization for a data set in a flexible way which is capable incorporating a variety of different “biases” into selecting an available visualization given the context.

User Utterance/Query

A user may issue a natural language query for data. A natural language query may be referred to herein as a user utterance, which may be a spoken or textual natural language user query. A user utterance is the base request used to generate a result. For example, a user utterance may be “what are the top songs by weeks on chart”. A user utterance may provide an indication of what visualization the user expects or would prefer to see.

For example, the user utterance may include an explicit request of a supported chart type. Within an utterance a user may specifically reference supported visualizations types by name. For instance, an utterance such as “top songs by weeks on chart as a bar chart” specifies that a bar chart visualization is preferred. Alternatively, an utterance such as “map displaying customer locations” indicates that a user prefers a map visualization.

In another example, phrasing may implicitly indicate the preferred visualization. In particular, other utterances may not call out a specific supported visualization by name. However, “better” visualizations of the data may be clearly indicated—albeit implicitly—in the utterance. For example words such as “show the difference between” or “correlate” have a strong bias towards specific visualization and visualization layouts.

Embodiments may include functionality for using a model (or models) selected to source data for results to also provide guidance on how to display data from the model. For example, in some embodiments, a visualization can be determined implicitly from the data requested. In particular, certain types of data have different commonly preferred visualization types. For instance the presence of: images, geo-coded attributes, or time, provide a source of bias towards different types of visualizations (e.g. collage, map, or graph respectively). Alternatively or additionally, a visualization can be determined explicitly as defined in a model. The creator of the model or default behavior of the model could explicitly define the default visualization for subsets of data within the model.

Embodiments may additionally or alternatively include input in the form of historical use by a user and/or machine learning. In some embodiments, a feedback loop is present that learns what types of visualizations are often paired, by historical user selection, with sets of data and this information can also be leveraged to bias the visualization selection.

Some embodiments implement what is referred to herein as a visualization bias pipeline. The visualization bias pipeline spans a natural language capability to interpret user utterances for phrasings related to preferred visualization type, aggregation of utterance interpretation, results, usage for machine learning, and/or the client rule sets to apply natural language interpretation and learned behavior to a specific set of visualizations supported by specific clients.

As noted, some embodiments implement a visualization bias and selection pipeline for a multi-client environment. The different clients may support different visualization capabilities. Embodiments may therefore include support for specific client-side rule sets for selecting and constructing visualizations based on specific client side capabilities.

Thus, some embodiments implement integration of multiple bias inputs for a “best” visualization into a single pipeline, including but not limited to one or more of (a) the extraction of natural language phrasings to bind to specific visualizations or bias eventual visualization selection; (b) expert system classification of preferred result visualization based on content of data to be visualized (holistically or of a specific data element) and/or based on past usage history by users; (c) visualization output capabilities of a client; and/or (d) statistical analysis of data to be displayed.

Some embodiments implement modification of data sets to be visualized (e.g. updating queries to include additional data or reshaping of data sets) based on a bias result.

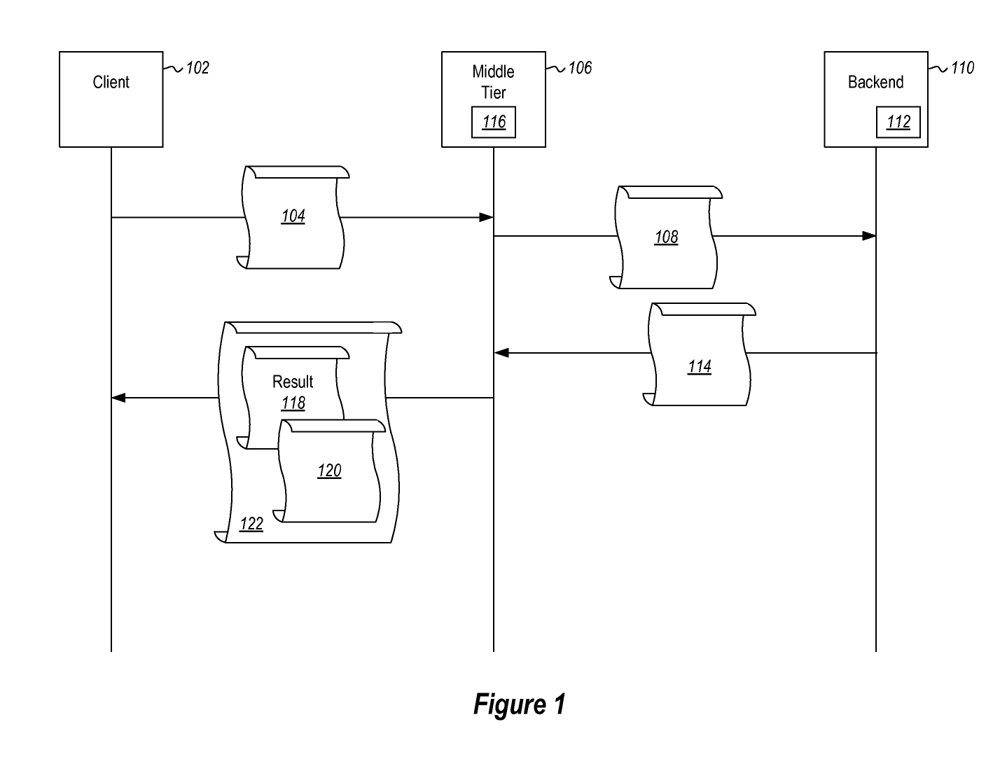

Referring now to FIG. 1, an example is illustrated. FIG. 1 illustrates a client 102. The client 102 sends a natural language clear query 104 to a middle tier 106. The middle tier 106 forwards the natural language query as an utterance 108 to a backend 110. The backend 110 includes a natural language component 112 that can isolate any explicit visualization requests and/or analysis intent within the utterance 108 which can be included in an interpretation response 114.

The interpretation response 114 includes a semantic query model of the natural language query 104. In particular, the backend 110 is able to use various semantic query tools to interpret the natural language query 104 to create a semantic model representation that can be used to obtain data from a data store.

At the middle tier, a visualization categorizer service 116 uses the interpretation response 114, the original natural language query 104, and various other pieces of metadata and rules to generate a user intent, one or more visualization types, and bindings. Bindings refers to what elements of the data to put on which part of the visualization (e.g. column A is set to (bound to) the x-axis and column b is set to (bound to) the y-axis, etc.). The user intent is a best guess, based on semantic interpretation, of what data a user is trying to obtain.

The one or more visualization types are visualizations that may be able to accurately represent returned data. The visualization types may be determined based on the natural language query 104, data to be compiled, and/or client capabilities. For example, as described above, the natural language query 104 may include language that would seem to indicate a user's preferred visualization type. For example, if the natural language query 104 includes language such as “as a pie chart” a determination can be made that a user would prefer that data be returned in a pie chart format.

The visualization types may be based on data to be compiled. For example, certain types of data may be displayed better using one visualization than another visualization. The type of data to be returned can be determined based on the semantic interpretation included in the interpretation response 114. Thus, this information may weigh in favor of one type of visualization over other types of visualizations. For example, a bar chart may be preferred for displaying comparisons among data whereas a pie chart may be preferred for percentage of a whole. Information that may be used to make such determinations may be information such as cardinality of data. In addition to cardinality embodiments may consider the distribution of actual values—meaning distance between minimum and maximum in relation to the mean and average of values. This can also be conceptualized as data density along each dimension of a chart.

This may also apply to data format. For example, latitude and longitude are esoteric numbers, but very meaningful in relationship to a known coordinate mapping (e.g. a map). This can be true of other types of data such as time on a timeline, % values (which could be inferred from the value range 0.0 to 1.00%) or currency.

Embodiments may also include functionality for formatting of output. In the same way embodiments learn/specify what chart type is used, embodiments can specify how to format the axis. For example, instead of 1000000 embodiments might show $1,000,000 or 1M based on the context of the data and user utterance.

The visualization types may be based on information known about the client 102. For example, if the middle tier 106 has information regarding what types of visualizations the client 102 is capable of displaying, or what types of visualizations the client 102 is better suited to display, this information can be used to weigh in favor of certain types of visualizations over other visualizations. This information may be provided to the middle tier 106 from the client 102. Alternatively, the middle tier may be aware of what the client 102 version is and from this information may be able to determine what visualizations the client supports. In particular, the middle tier 106 may store information regarding clients that can connect to the middle tier and what visualizations they support. In yet another alternative, an administrator may be able to identify to the middle tier what visualizations are supported by the client 102. Other alternatives, though not enumerated here, may be implemented.

In some embodiments, the visualization types may be expressed in a list. The list may be a biased list such that visualizations in the list can be preferentially selected based on a bias applied to any given visualization. Thus, when data is returned to the client 102, the data can be returned using a selected visualization, or alternatively the data may be returned to the client with a suggested visualization.

At the client 102, the client can apply a set of visualization selection heuristics that conform to visualization capabilities of the client to update the visualization types information as needed and select the best visualization for rendering at the client 102. Thus as illustrated in FIG. 1, the middle tier may return to the client 102 data results 118 and visualization information 120.

Interpretation Result: VisualizationInfo:

A visualization bias is passed from the middle tier 106 to the client 102 within the visualization information 120 within an interpretation result 122. The visualization bias includes a list with visualization definition entries. Each entry includes, for example: a visualization type; a definition source; entity bindings to the visualization type; and a confidence score. Multiple visualization definitions are listed because each step in the visualization bias pipeline can add new potential visualizations if there is confidence that a different visualization would be a better fit than existing visualizations included in the interpretation result 122.

Each visualization definitions entry may be one of a number of different visualization types. For example, a visualization type of a visualization definition entry may be a table, bar chart, line chart, scatter plot, bubble chart, animated bubble chart, matrix, pie chart, organization chart, timeline, card display, etc.

As noted above, a definition source may be included in each visualization definitions entry. This field defines from where the visualization type was identified. For example, this field can indicate that the visualization type was identified based on explicit instruction from the user, from a model definition, from heuristics, or from some other source.

Embodiments may facilitate entity bindings. Entities are the columns, tables, filters, etc. and bindings are the part of the visualization they are assigned to.

As noted above, a confidence score may be included in each visualization definitions entry. The confidence score is a bias factor that can be used to rank visualizations to allow the client 102 to select the “best” visualization. The confidence score may be a raw number, a percent confidence, a position in a ranked chart, a delineated category, or some other indicator.

Client Side Visualization Construction Rules

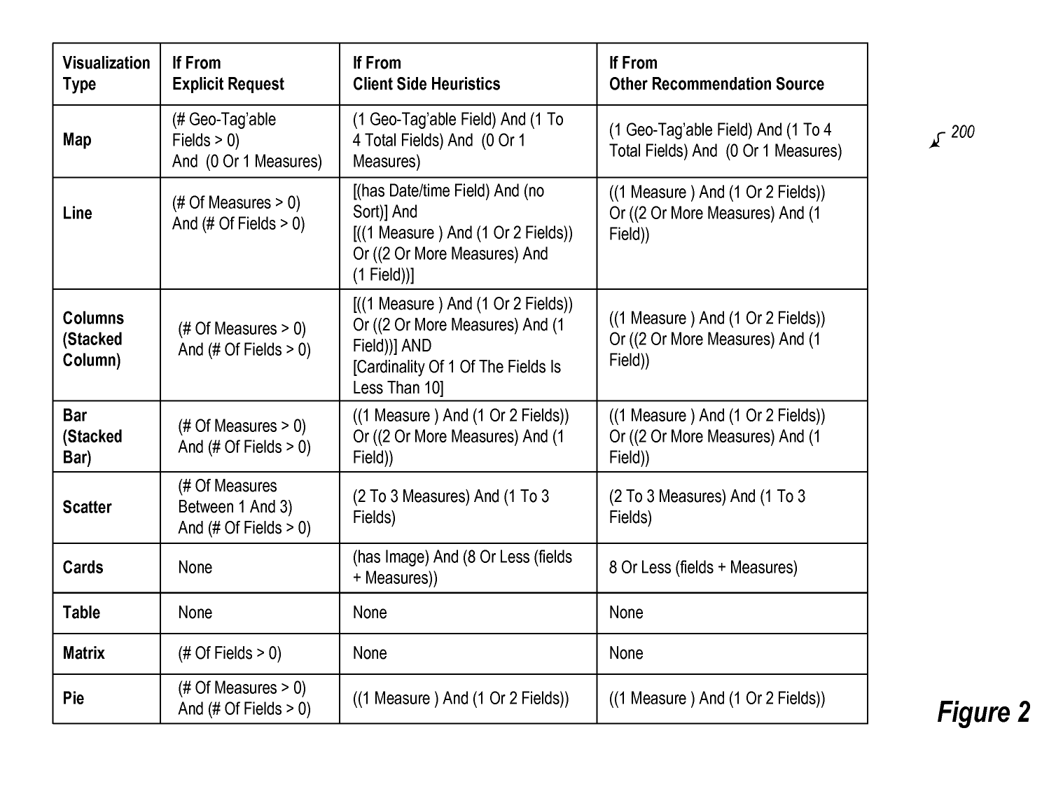

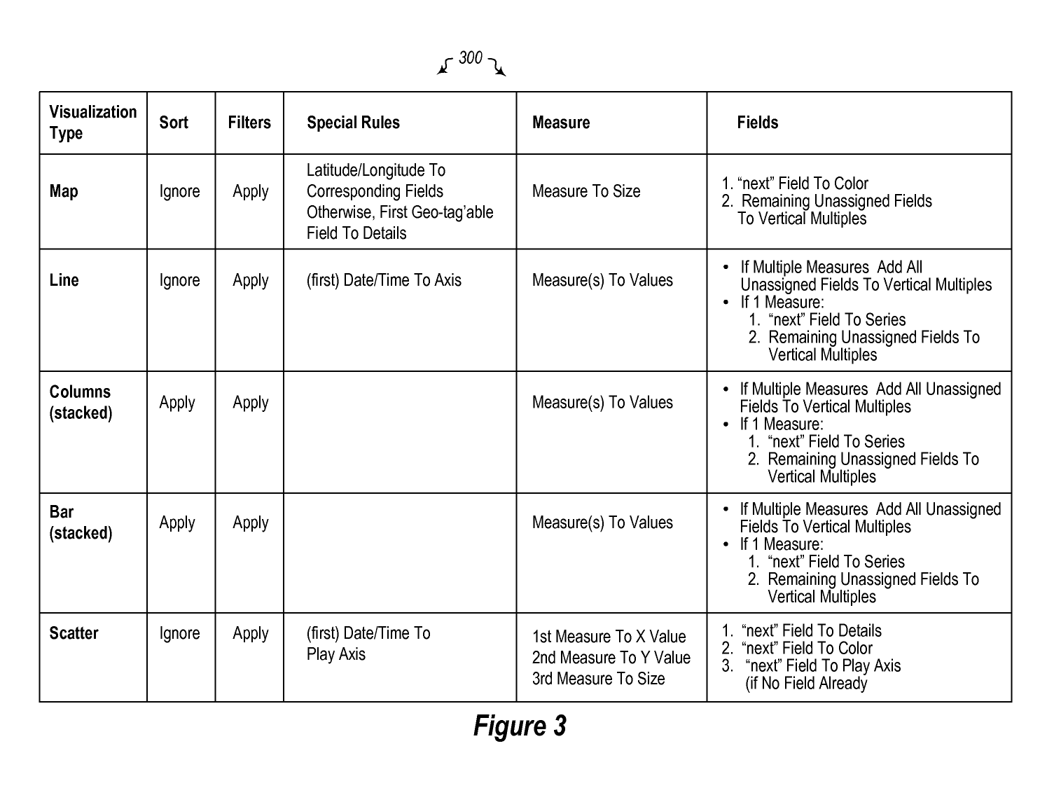

At the client 102, visualization selection and construction is performed. If there is an explicit request from a user for a visualization, the client can check to see if the semantic query meets the rules for that visualization. For example FIG. 2 illustrates visualization selection rules that can be evaluated to determine if visualization can be used. The client 102 can then simply construct that visualization if it meets that criterion. FIG. 3 illustrates rules used to construct visualizations.

Otherwise, the client can iterate through the other visualization options in the visualization information in a prioritized order based on a bias indicated by the confidence score. If the semantic query meets a visualization requirement, that visualization will be selected and it will be constructed, otherwise, the next visualization in the prioritized order will be evaluated to determine if the semantic query meets visualization requirements for that visualization. For example, consider the following prioritized list of visualizations.

1. Map

2. Line

3. Column (stacked)

4. Bar (stacked)

5. Scatter

6. Cards

7. Table

The ordering of the list represent biasing of the list items, where “Map” is the preferred visualization and “Table” is the least preferred visualization based on a bias ranking A determination can be made whether or not a visualization is appropriate based on the evaluation of various visualizations in the list. For example, the table 200 shown in FIG. 2 illustrates evaluation rules that can be evaluated to determine if a visualization is appropriate. As noted, each of the visualizations is evaluated in order based on their bias scores. The table 200 in FIG. 2 illustrates that each rule takes into account the source of the visualization recommendation, i.e. the definition source. In the illustrated example, three groups of sources are shown: explicit requests from the natural language query, client side heuristics, and other sources.

The table in FIG. 2 illustrates various determination made with regard to whether or not data items in a data set to be visualized have Geo-Tag'able fields and in some cases the number of Geo-Tag'able fields for each data item. Determination of whether a field is Geo-Tag'able may come from the reporting properties on the field. For example, the following data categories within a Geography category apply to Geo-Tag'able fields:
Address
City
Continent
Country/Region
Country
Postal Code
State or Province
Latitude
Longitude

FIG. 2 further illustrates that rules evaluate the total number of fields for data items and the number of measures for data items. Measures, as used herein, are property values used in a visualization. For example, a measure may be a size or a color.

Referring now to FIG. 3, a table 300 with a set of visualization construction rules is illustrated. In the table 300 various visualization types are illustrated. The table illustrates, in one example embodiment, if sorting is applied or ignored for each visualization, if filters are applied to restrict which data to display in a visualization, any special rules that are applied to each visualization, how measures are displayed for each visualization, and how fields are displayed. In the fields column, “next” implies that measures/fields are placed in the order encountered in the semantic query

If there is an ambiguous join path between tables in a result, the semantic query disambiguates the path by including an additional filter from the table being joined through. For instance: If the query were “Customer Products” and the table/joins available were—C:Customer, P:Product, S:Sales, R:Returns: the semantic query result could be either “Customers who bought products” (join through sales) or “Customer who returned products” (join through returns). To disambiguate the semantic query would contain a filter for “Sales>0”. The client will then have to add the joins for C-S, S-P explicitly based on this implicit factor.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

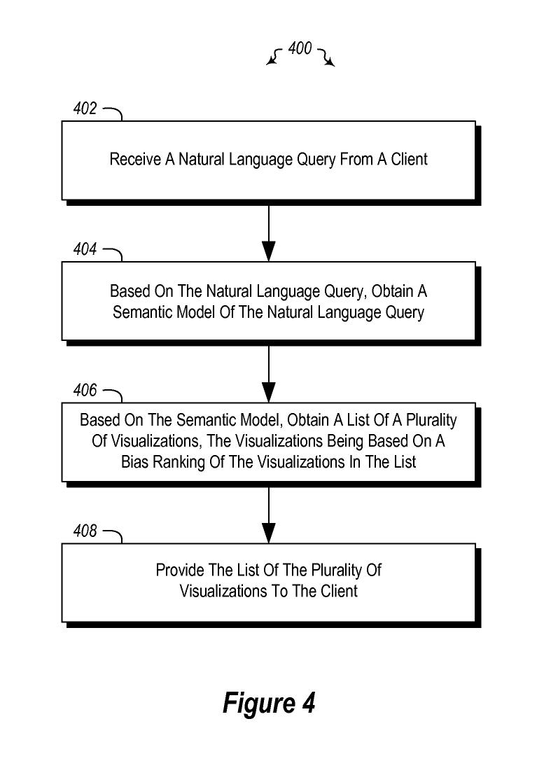

Referring now to FIG. 4, a method 400 is illustrated. The method 400 includes acts for providing visualizations based on natural language searches. The method includes receiving a natural language query from a client (act 402). For example, if the method were being performed by the middle tier 106; a natural language query 104 may be received directly from the client 102.

The method 400 further includes, based on the natural language query, obtaining a semantic model of the natural language query (act 404). For example, from the perspective of the middle tier 106, the semantic model may be included in the interpretation response 114 obtained from the backend 110.

The method 400 further includes based on the semantic model, obtaining a list of a plurality of visualizations (act 406). The visualizations are based on a bias ranking of the visualizations in the list. In particular, the list has a bias ranking to identify visualizations in an order of preference given various factors as discussed below. In the example illustrated above, the list may be generated by the middle tier 106 using the semantic model, client capabilities, returned data itself, etc.

The method 400 further includes providing the list of the plurality of visualizations to the client (act 408). At the client a set of visualization construction rules are applied to select a visualization from the list to apply results from the natural language query to the visualization. For example, as illustrated above, a client 102 can apply rules, such as those illustrated in FIG. 2, to select an appropriate visualization.

The method 400 may be practiced where the client applies visualization construction rules to visualization on the list dependent on how the visualization was added to the list. For example, as illustrated above, the visualization rules are applied with consideration given to if the visualization was determine from an explicit request, from client side heuristics and if from other recommendation sources.

The method 400 may be practiced where the visualizations are based on a bias ranking, the bias ranking taking into account client capabilities. As noted, some clients may not be able to display certain visualizations or may not be able to display them as well as other visualizations. Thus, the bias ranking can take this into account when ranking visualizations.

The method 400 may be practiced where the visualizations are based on a bias ranking, the bias ranking taking into account machine learning. For example, historical user interaction with visualizations may affect how future visualizations are displayed. For example, if a user consistently changes line charts to bar charts, then embodiments may start providing biasing bar charts higher than line charts.

The method 400 may be practiced where the visualizations are based on a bias ranking, the bias ranking taking into account data results from the request. As noted, certain data results are better visualized with certain visualizations. For example, comparisons may be better visualized using bar charts than pie charts. Thus, if data results returned would be better visualized using one visualization over another, then the better visualization may have a higher bias ranking

The method 400 may be practiced where visualizations are based on a bias ranking, the bias ranking taking into account explicit user direction in the natural language search. For example, the user direction may include key words such as compare (which might suggest a bar chart or other comparison type chart), where (which might suggest a map or other chart), etc. Alternatively or additionally, the user direction in the natural language search might include direction to use a specific visualization. For example, an utterance may include the terms “bar chart”, “line chart” or “map”, thereby suggesting that one of those visualizations be used.

The method may further include updating the semantic model of the natural language query to obtain data results to be able to provide a preferred visualization from the bias list. For example, additional results may need to be obtained to be able to properly display a given visualization. The semantic model can be updated to obtain the additional results to properly display the visualization.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of providing visualizations based on natural language searches, the method comprising:
receiving a natural language query from a client;
based on the natural language query, obtaining a semantic model of the natural language query;
based on the semantic model, obtaining a list of a plurality of visualizations, the visualizations being based on a bias ranking of the visualizations in the list; and
providing the list of the plurality of visualizations to the client, where at the client a set of visualization construction rules are applied to select a visualization from the list to apply results from the natural language query to the visualization.

2. The method of claim 1, wherein the client applies visualization construction rules to visualization on the list dependent on how the visualization was added to the list.

3. The method of claim 1, wherein the visualizations are based on a bias ranking, the bias ranking taking into account client capabilities.

4. The method of claim 1, wherein the visualizations are based on a bias ranking, the bias ranking taking into account machine learning.

5. The method of claim 1, wherein the visualizations are based on a bias ranking, the bias ranking taking into account data results from the request.

6. The method of claim 1, wherein visualizations are based on a bias ranking, the bias ranking taking into account explicit user direction in the natural language search.

7. The method of claim 1, further comprising updating the semantic model of the natural language query to obtain data results to be able to provide a preferred visualization from the bias list.

8. A computing system for providing visualizations based on natural language searches, the system comprising:
one or more processors; and
one or more computer readable media, wherein the one or more computer readable media comprise computer executable instructions that when executed by at least one of the one or more processors cause the system to perform the following:
receiving a natural language query from a client;
based on the natural language query, obtaining a semantic model of the natural language query;
based on the semantic model, obtaining a list of a plurality of visualizations, the visualizations being based on a bias ranking of the visualizations in the list; and
providing the list of the plurality of visualizations to the client, where at the client a set of visualization construction rules are applied to select a visualization from the list to apply results from the natural language query to the visualization.

9. The system of claim 8, wherein the client applies visualization construction rules to visualization on the list dependent on how the visualization was added to the list.

10. The system of claim 8, wherein the visualizations are based on a bias ranking, the bias ranking taking into account client capabilities.

11. The system of claim 8, wherein the visualizations are based on a bias ranking, the bias ranking taking into account machine learning.

12. The system of claim 8, wherein the visualizations are based on a bias ranking, the bias ranking taking into account data results from the request.

13. The system of claim 8, wherein visualizations are based on a bias ranking, the bias ranking taking into account explicit user direction in the natural language search.

14. The system of claim 8, further comprising updating the semantic model of the natural language query to obtain data results to be able to provide a preferred visualization from the bias list.

15. A physical computer readable storage medium comprising computer executable instructions that when executed by one or more processors causes the following to be performed:
receiving a natural language query from a client;
based on the natural language query, obtaining a semantic model of the natural language query;
based on the semantic model, obtaining a list of a plurality of visualizations, the visualizations being based on a bias ranking of the visualizations in the list; and
providing the list of the plurality of visualizations to the client, where at the client a set of visualization construction rules are applied to select a visualization from the list to apply results from the natural language query to the visualization.

16. The computer readable medium of claim 15, wherein the visualizations are based on a bias ranking, the bias ranking taking into account client capabilities.

17. The computer readable medium of claim 15, wherein the visualizations are based on a bias ranking, the bias ranking taking into account machine learning.

18. The computer readable medium of claim 15, wherein the visualizations are based on a bias ranking, the bias ranking taking into account data results from the request.

19. The computer readable medium of claim 15, wherein visualizations are based on a bias ranking, the bias ranking taking into account explicit user direction in the natural language search.

20. The method of claim 1, further comprising updating the semantic model of the natural language query to obtain data results to be able to provide a preferred visualization from the bias list.
